(19) United States
(12) Patent Application Publication
(10) Pub. No.: US 2024/0360814 A1
(43) Pub. Date: Oct. 31, 2024

(54) VERTICAL AXIS WIND TURBINE

(71) Applicant: IF-ADAMAS B.V., Doetinchem (NL)

(72) Inventor: Frederikus Hendrikus Gerardus Uytdewilligen, Braamt (NL)

(73) Assignee: IF-ADAMAS B.V., Doetinchem (NL)

(21) Appl. No.: 18/576,597

(22) PCT Filed: Jul. 7, 2022
(86) PCT No.: PCT/NL2022/050389

§ 371 Date: Jan. 4, 2024

(30) Foreign Application Priority Data
Jul. 9, 2021 (NL) 2028678

(51) Int. Cl. F03D 3/04

(52) U.S. Cl. CPC F03D 3/0409; F05B 2240/12; F05B 2240/211

(57) ABSTRACT

A vertical axis wind turbine includes a stator with a top and a bottom and a rotor including a plurality of blades rotatably arranged between the top and the bottom. The stator includes a plurality of guide vanes arranged around the rotor and extending between the top and the bottom. Each of the plurality of guide vanes is arranged at a non-zero angle with respect to the axis of rotation, as seen in a plane normal to the radial direction.

The invention relates to a vertical axis wind turbine, in particular a Savonius type wind turbine, comprising a stator with a top and a bottom and a rotor comprising a plurality of blades rotatably arranged between the top and the bottom, the rotor defining an axis of rotation, a radial direction and a circumferential direction, the stator further comprising a plurality of guide vanes arranged around the rotor and extending between the top and the bottom.

Wind turbines can be used to convert kinetic energy of wind into electric energy by rotating under influence of the wind and thereby driving an electric generator. Horizontal axis wind turbines have blades which rotate around a horizontal axis. In order to improve cost efficiency, wind turbines of this type have become bigger and bigger. Bigger wind turbines in general produce more power, but are also less well-received. As an example, horizontal axis wind turbines of sufficient size often have blade speeds so high, that birds can not anticipate the blades' movement, and are as such struck and killed by them. It appears this problem can be at least partially solved by painting at least one blade of the wind turbine to a dark colour. However, dark-coloured blades are no solution for populated areas, as in general the population does not accept such wind turbines due to their striking looks. Further, horizontal axis wind turbines in general have blade tip speeds which far exceed the wind speed. Thus, at least the tips of the blades cut through the wind at high speed, thereby making a relatively loud noise. The noise makes it even more difficult for the population to accept horizontal axis wind turbines.

Vertical axis Savonius type wind turbines have rotor blades which rotate, during a portion of a single rotation, in the wind direction. The speed of the rotor blades is, in principle, limited to the wind speed. Therefore, such wind turbines have the inherent advantage that they are less noisy, and that they operate at speeds which cause little to no problems to birds. The lack of speed may come at an efficiency penalty, but may be compensated at least in part by providing a stator around the rotor, stator comprising vertical guide vanes to direct wind into the rotor blades on one side of the wind turbine, thereby increase the local air speed, and to block the wind from passing to the rotor blades on the opposing side, thereby removing air resistance for the back-travelling rotor blades. An important advantage of vertical axis wind turbines is that they need not be rotated to a specific wind direction. As such, vertical axis wind turbines can be made of relatively elegant and robust design, thereby enhancing reliability.

An example vertical axis wind turbine is known from U.S. Pat. No. 6,740,989. This prior art vertical axis wind turbine comprises a turbine rotor with rotor blades disposed for rotation about a substantially vertical axis. The turbine includes multiple vertically extending guide vanes circumferentially spaced apart about the rotor to direct wind into the rotor on one side thereof, and block the wind on the other, opposing side.

In order to make vertical axis wind turbines, such as that of U.S. Pat. No. 6,740,989 viable for mass use, they need to be more cost efficient.

For that reason, the current application sets as its object to increase the efficiency of the known vertical axis wind turbine, so that the cost efficiency increases as well.

The object is achieved by a vertical axis wind turbine as referred to in the preamble that is characterised, in that each of the plurality of guide vanes is arranged at a non-zero angle with respect to the axis of rotation, as seen in a plane normal to the radial direction.

Due to the angled, or tilted or slanted, configuration of the guide vanes of the stator, a flow of air from the guide vanes may be supplied gradually to the rotor blades. The gradual supply of air is easiest explained in contrast to the prior art wind turbines, in which both the rotor blades and the guide vanes are arranged vertically. As the rotor rotates, the rotor blades pass by a guide vane. When a rotor blade approaches a guide vane, wind guided by that guide vane is guided to the rotor blade preceding the approaching rotor blade. As soon as the rotor blade aligns with the guide vane, the wind is instead guided to the rotor blade at hand. Accordingly, there is a sudden jump in load on the rotor blade caused by the switch in wind. The jump in load has several effects detrimental the wind turbine. First and foremost, it limits efficiency. Secondly, it creates relatively high peak mechanical stresses, and thirdly, it creates a relatively large amount of noise. By angling the guide vanes with respect to the rotational axis, and thus with respect to the rotor blades, the rotor blades do not align along their entire length with the guide vanes at any one point during the rotation. Instead, at any moment, only a portion or point of the rotor blade aligns with the guide vane. Said portion or point travels up or down along the guide vane as the rotor moves, much like a cutting motion. The wind guided by the guide vane is therefore guide to the rotor blade as long as the rotor blade partially aligns with the guide vane. The angled setup of the guide vanes accordingly creates a smooth supply of air during a prolonged period, thereby removing the sudden jumps in load on the rotor blades.

As an added effect, the angled position of the guide vanes may also offer stiffness to the structure in a material-efficient manner, for instance by being part of a triangle-frame. As a result the stator may be sufficiently strong to function as a holder or housing for the rotor. This removes the need to place a central axle to carry the rotor blades. The absence of such an axle allows creating a through flow from one rotor blade to the next in the central area of the rotor, thereby making the vertical axis wind turbine suitable to be configured as a Savonius wind turbine.

The guide vanes may be arranged at different angular positions around the rotor.

Therefore, in one embodiment the vertical axis wind turbine is of the Savonius type. In such a type, wind guided into one rotor blade, sometimes referred to as a scoop, is changes direction as it pushes the rotor blade forward, and is guide by the rotor blade to the centre of the rotor. Through the through flow in the centre, the wind is fed to another rotor blade, where the wind, due to its changed direction, can further aid to push the next rotor blade in the same rotational direction as the first.

Preferably, one or more pairs of consecutive guide vanes as seen in the circumferential direction join at an apex. Such a triangular or truss construction can further enhance efficiency of the wind turbine, by providing a smooth transition of the rotor blades at the apex from one guide vane to the next. As the rotor blade passes the apex, it moves away from one guide vane, but towards another at the same time. As such, the rotor blade is always provided with wind from one of the two guide vanes, and no sudden jumps in load on the rotor blade occur. When guide vanes meet at an apex, this also further enhances stiffness of the structure.

The apex may be adjacent the top or adjacent the bottom. Alternatively or additionally, the guide vanes may be joined crosswise, such that the apex at the joining point at the centre of the resulting cross is at substantially equal distance from the top and bottom.

It is further preferred if each of the plurality of guide vanes shares a respective apex with two neighbours. This way, the guide vanes collectively complete surround the rotor without gaps. Thus, any one rotor blade aligns, more specifically a portion thereof, aligns with one of the guide vanes at any rotational position of the rotor. Thus, the supply of wind to the rotor blades becomes very smooth.

According to an embodiment of the vertical axis wind turbine, each of the plurality of guide vanes extends at a non-zero angle with respect to the radial direction, as seen in a plane normal to the axis of rotation. Each vane may thus have on either side thereof respectively a surface facing substantially radially inward and a surface opposite thereto facing substantially radially outward. May aid in guiding wind out of the centre of the rotor, thereby engaging the rotor blades at a distance from the centre, and thus providing a larger torque.

According to a further embodiment of the wind turbine, each of the plurality of guide vanes comprises an inner segment and an outer segment as seen in the radial direction, wherein the inner and outer segments are mutually inclined. Each vane may thus be curved, bent and/or folded about a line, which may be substantially straight. Accordingly the segments mutually extend at a non-zero angle as seen in a plane normal to the axis of rotation.

The inclined segments increase the area moment of inertia of the guide vanes, thereby contributing to preventing buckling and/or torsion, particularly when the guide vanes are planar, e.g. made of sheet metal. Thus, the embodiment at hand allows an efficient manufacturing of a stator with rigid guide vanes. Further, even more so in case the vanes are at an angle with the radial direction, the inclination of the segments allows neighbouring vanes to be arranged in a coinciding manner, particularly at their shared apex. This way, the vanes can be positioned relatively close to one another to obtain a compact and rigid stator that can be conveniently assembled.

As an example, the vanes may be folded so that the vanes are concave and/or convex in respectively the same circumferential direction to obtain a rotationally symmetric stator, thereby contributing to evenly dosing the incoming air flow to the rotor.

Preferably, the inner and/or outer segment is substantially planar. Additionally or alternatively, the inner segment and/or outer segment are preferably substantially triangular or trapezial as seen in plane view, the inner and outer segment meeting along a contact line. Such shapes delimited by said line across the vane can be formed in an elementary manner. For instance, the inner segment may be substantially triangular and the outer segment may be substantially trapezial or vice versa. Moreover, it is possible to manufacture a guide vane from a single piece of sheet metal, simply by folding the sheet metal in order to create the mutually inclined segments.

It is then further preferred if respective contact lines of consecutive vanes extend, as seen in a direction from the top to the bottom, alternatingly radially inwards and radially outwards. This further enables a compact arrangement of the vanes to obtain a more compact and rigid stator, since it further enables neighbouring vanes to coincide at their shared apex.

According to a further embodiment, the guide vanes extend partially beyond the top and/or bottom in the radial direction. Thereby a stator with a relatively large diameter can be obtained, without requiring a top and/or bottom of the same large diameter.

The guide vanes may have rounded corners on their outsides.

According to a further embodiment, any one or more of the top, the bottom, the guide vanes and the rotor comprise sheet material, such as sheet metal, in particular steel. The use of sheet material, in particular sheet metal, for the construction of the wind turbine may be relatively cost effective. It should be noted that due to the design described above, the wind turbine is sufficiently strong to allow a relatively thin sheet (metal) structure. Said components may further include frame elements, particularly when the wind turbine is manufactured at a height of over 15 meters. Alternatively, any one or more of the top, the bottom, the guide vanes and the rotor may be manufactured from the sheet material, such as metal, such as steel.

According to a further embodiment, the top and/or bottom is annular or disk-shaped. A material-efficient top and/or bottom that corresponds to the arrangement of the guide vanes can thereby be obtained, since the vanes are preferably arranged in an annular array, i.e. around the rotor. A disk-shaped top or bottom may enable a bearing mechanism for the rotor to be provided in the respective top or bottom.

A further embodiment of the vertical axis wind turbine comprises two, three or more of such stators and rotors stacked coaxially. An increasing number of pairs of a stator and a rotor increases the combined power output of the turbine. By stacking the pairs coaxially, an efficient configuration is obtained, in which a rotor does not obstruct the performance of another rotor. The wind turbine as described herein allows a modular build-up by choosing the suitable amount of stators and rotors for a particular wind turbine.

Preferably, the guide vanes of adjacent stators are aligned. By aligning the guide vanes, the adjacent rotors can be placed in equal orientation, thereby facilitating mounting several rotors to each other. Additionally or alternatively, such a configuration may facilitate offsetting the rotors in their rotational position.

The rotors of adjacent stators are preferably offset in the circumferential direction. The offset rotors, more specifically a phase difference of the respective pluralities of rotor blades, damp natural oscillations resulting from rotation of the rotors. This lowers the structural requirements for the turbine, further enabling material-efficiency of the turbine. Moreover, the rotors being offset reduces the risk of resonance resulting in damage to the turbine.

Particularly in that case, the respective rotors are preferably arranged mutually stationary. This way, it can be ensured that the rotors remain rotationally offset. Further, mutually stationary rotors may be suspended together between bearings, thereby thus requiring only a limited amount of bearings for all rotors combined.

A further embodiment of the wind turbine further comprises a stand. The stator may be fixed to the stand. In case the turbine comprises multiple stators and rotors stacked coaxially, the each stator is fixed to the stand, e.g. directly or via one of the other stators. The stand may enable the turbine to be positioned at a desired height, e.g. at a heigh with larger air flows.

A further embodiment further comprises a generator fixed on or in the stand and connected to the rotor. In case the turbine comprises multiple stators and rotors stacked coaxially, the generator is connected to one or all of the multiple rotors. The generator is arranged to generate electric energy using the rotation of the rotor.

The invention will be further explained with reference to the attached drawings, in which:

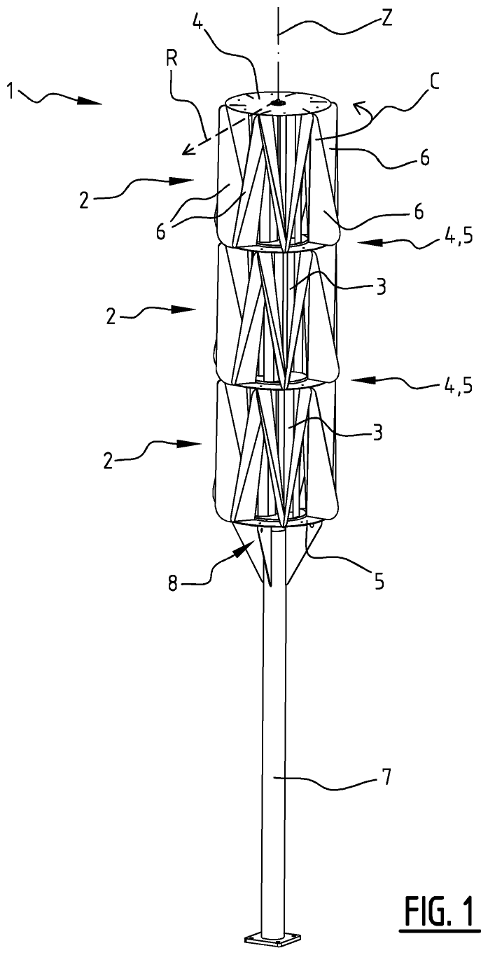

FIG. 1 shows schematically a perspective view of a vertical axis wind turbine with three rotors and stators;

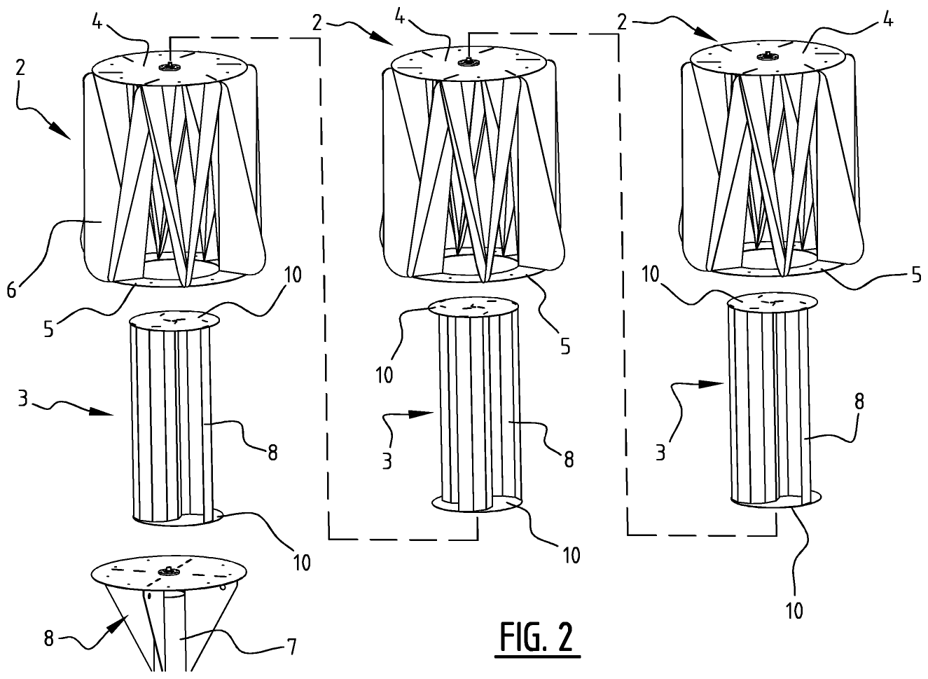

FIG. 2 shows a blow up view of the wind turbine of FIG. 1:

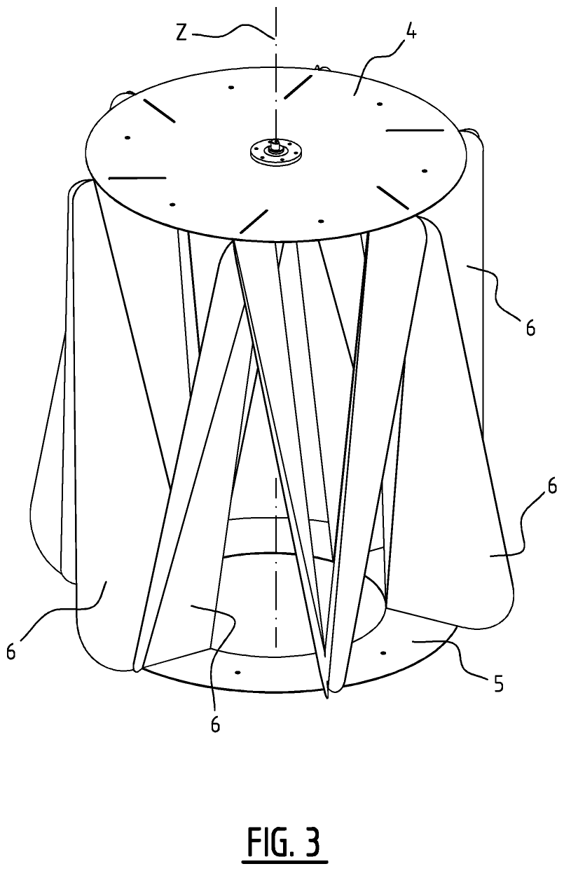

FIG. 3 shows a perspective view of a stator of the wind turbine of FIG. 1:

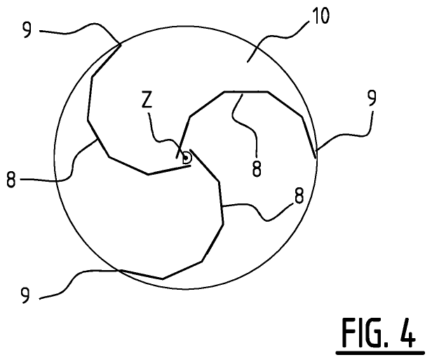

FIG. 4 shows a cross-sectional view of a rotor of the wind turbine of FIG. 1:

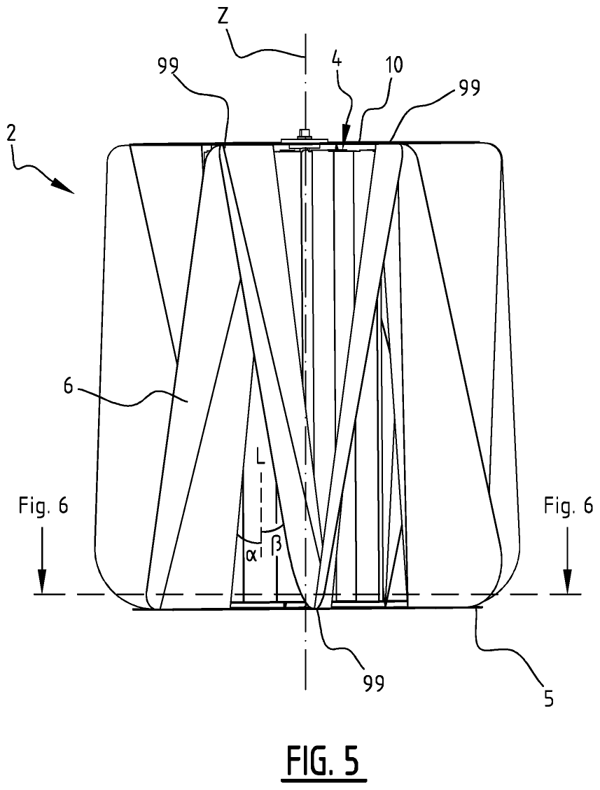

FIG. 5 shows a side view of a rotor and a corresponding stator of the wind turbine of FIG. 1:

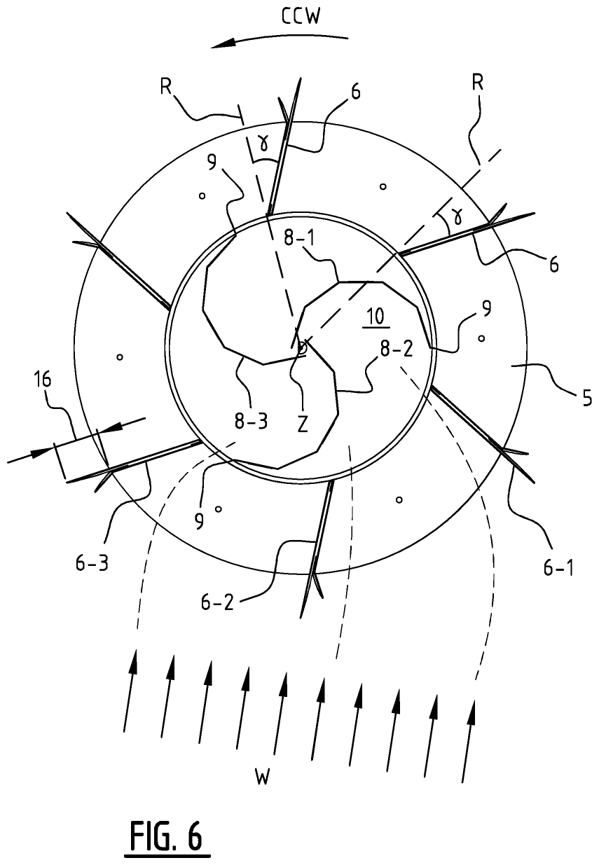

FIG. 6 shows a cross-sectional view of a rotor and a corresponding stator of the wind turbine of FIG. 1; and

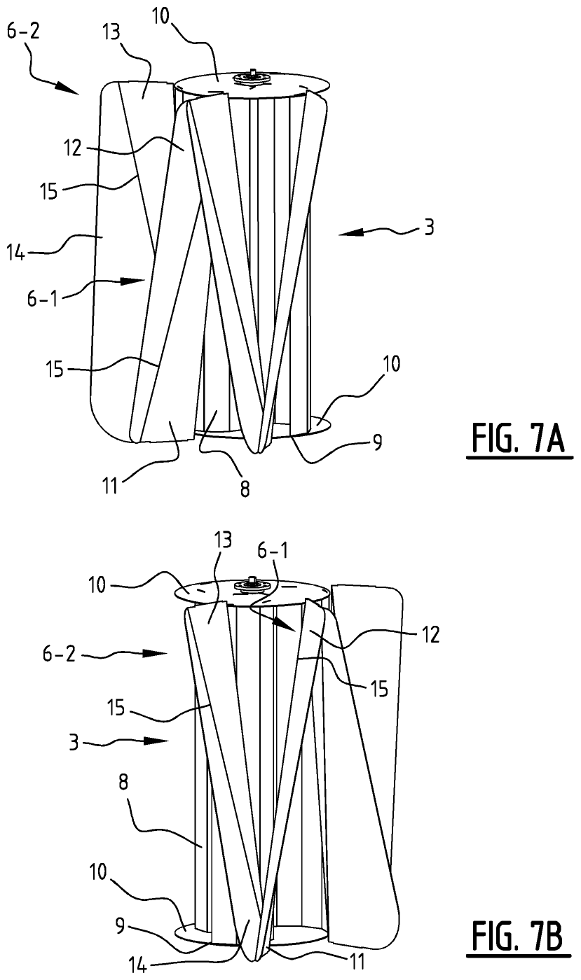

FIGS. 7A and 7B show two different side views of a rotor and two guide vanes of the wind turbine of FIG. 1.

Throughout the figures, like elements will be referred to using like reference numerals.

FIG. 1 shows a vertical axis wind turbine 1, comprising three stacked stators 2, having disposed in each one of them a rotor 3. Each stator 3 has a top 4 and a bottom 5. As an example, the top 4 is disk-shaped and the bottom is annular. The rotor 3 defines an axis of rotation Z, as well as a circumferential direction C and a radial direction R. The stator 2 comprises a plurality of guide vanes 6 which are arranged around the rotor 3 at different angular positions. The guide vanes 6 extend between the top 4 and bottom 5 of each stator 2. For the sake of simplicity, not all guide vanes 6 have been provided with a reference numeral. The stack of stators 2 and rotors 3 is fixed on a stand 7, which defines a receiving space 8 for a generator. The generator itself is not shown. FIG. 2 shows in blow up view the stators 2 and rotors 3 of FIG. 1. It can be seen from FIG. 2 that the stators 3 can be placed over their respective rotors 2 in order to build up the wind turbine 1. Details with respect to the rotors 3 and stators 2 will be described with respect to the following figures.

As can best be seen in FIG. 5, the guide vanes 6 are arranged at a non-zero angle with respect to the axis of rotation Z. The angles α, β for two guide vanes 6 are shown using a support line L parallel to the axis of rotation Z. The guide vanes 6 meet each other at apexes 99 on near the top 4 or bottom 5 of the stator 2. All guide vanes 6 meet with another stator vane 6 at either end, so that a zig-zag shape of guide vanes 6 runs along the circumferential direction of the stator 2.

Referring now to FIG. 3, rotor blades 8 of the rotor 3 can be identified. The rotor blades 8 are made up of flat sections at a non-zero angle with respect to each other, thereby making an arcuate shape. The rotor blades 8 can be thought of as scoups or buckets catching air flow. The rotor blades 8 extend substantially parallel to the axis of rotation Z. Rotor disks 10 have been provided to support the blades 8. The rotor blades 8 end in a tip 9 in the radially outwards direction. It can further be seen that near the rotational axis Z a space is left between the rotor blades 8, so that wind may pass from one to the other. It is noted that no central axle is provided extending through the rotor 3, thereby leaving free this distance between the rotor blades 8.

Next, referring to FIG. 6, which is a cross section of the stator 2 and rotor 3 taken near the bottom 4, it can be seen the guide vanes 6 extend at a non-zero angle with respect to the radial direction R. The angle γ has been made visible for two guide vanes 6 near the top of FIG. 6 by drawing the local radial direction R using a dashed line. The non-radial orientation of the guide vanes 6 aids in guiding wind into rotor blades 8-1 to 8-3 (collectively referred to as rotor blades 8) of the rotor 3. Individual guide vanes 6-1 to 6-3 have been identified to facilitate explaining their function, however they do not differ from other guide vanes 6. As such, all guide vanes 6 are referenced throughout this application using reference numeral 6. The suffixes 1 to 3 are used merely to identify unique ones of the guide vanes 6. When the wind W is incoming, shown by arrows on the bottom left of FIG. 6, guide vanes 6-2 and 6-3 direct the wind W into a first rotor blade 8-1 as is shown by dashed-dotted lines. This causes the rotor 3 to rotate in a counter clockwise direction CCW. As a result, another rotor blade 8-2 moves against the direction of the wind W, and would normally cause a relatively large amount of drag. However, due to the presence of stator vanes 6-2 and 6-1, the wind W is guided into a third rotor blade 8-3 instead. As a result, the returning rotor blade 8-2 encounters a relatively small flow of air, or no air flow at all, whereas the opposite rotor blades 8-3 and 8-1 moving with the wind direction W are driven by an increased air flow. As such, blade tips 9 of the rotor blades 8 may rotate at a speed that is higher than the actual wind speed, as the local wind speed at the tips and blades is increased by the guide vanes 6. FIG. 6 further shows that the guide vanes 6 extend outwards beyond the bottom 5 by an overlength 16. Although not visible in FIG. 6, the same overlength can be defined at the top 4, which has the same outer dimensions as the bottom 5.

Reference is now made to FIGS. 7A and 7B which show two adjacent guide vanes 6-1, 6-2 in more detail from two different side view angles. Each guide vane 6 comprises an inner segment 11, 13 and an outer segment 12, 14. The inner 11, 13 and outer segments 12, 14 are mutually inclined, i.e. they are arranged at a non-zero angle. In principle, the segments 11-14 could be e.g. curved, however in the wind turbine 1 of the figures, guide vanes 6 comprise planar segments 11-14 only. The planar segments 11-14 therefore meet at a contact line 15 which extends from the top 4 to the bottom 5 of the stator 2. The contact line 15 forms an edge. The planar segments 11-14 each are substantially triangular in shape, so that the contact lines 15 of the guide vanes 6 extend from the inside of the stator 3 towards the outside. When viewed in a direction defined from the bottom 5 to the top 4, the contact line 15 of a first guide vane 6-1 starts near the axis of rotation Z and moves outwards. The contact line 15 of the adjacent guide vane 6-2 starts on the outside and moves inwards towards the axis of rotation Z. As such, each segment 11-14 is substantially triangular, al be it with rounded edges. A similar shape can be achieved using preferably planar trapezial segments 11-14.

The top 4, bottom 5, guide vanes 6 and rotor 3 are constructed from steel plating, that is steel sheet metal. Some connections, e.g. between the rotor disks 10 and rotor blades 8 have been made using welding. Other connections, such as between stacked stators 2 have been made using rivets.

Now referring again to FIG. 1, the stacked stators 2 are aligned in their rotational position, so that their respective stator blades 6 are all at the same position, i.e. they are aligned. The rotors 3 however, are rotationally offset with respect to each other. The rotors 3 are mutually stationary, so that they all rotate together and their mutual rotational position does not change.

Throughout this application, a non-zero angle is understood to mean an angle larger than zero degrees, which is smaller or larger than 180 degrees. Thus, a non-zero angle is also understood to be a non-straight angle. A non-zero angle may be acute or obtuse, or might be a right or reflex angle.

Although the invention has been described above with reference to particular examples and embodiments, the scope of the invention is not limited thereto. In fact, the scope is also defined by the claims, which now follow.

1. A vertical axis wind turbine, comprising a stator with a top and a bottom and a rotor comprising a plurality of blades rotatably arranged between the top and the bottom, the rotor defining an axis of rotation, a radial direction and a circumferential direction, the stator further comprising a plurality of guide vanes arranged around the rotor and extending between the top and the bottom,
wherein each of the plurality of guide vanes is arranged at a non-zero angle with respect to the axis of rotation, as seen in a plane normal to the radial direction.

2. The vertical axis wind turbine according to the previous claim, wherein one or more pairs of consecutive guide vanes as seen in the circumferential direction join at an apex.

3. The vertical axis wind turbine according to claim 2, wherein each of the plurality of guide vane shares a respective apex with two neighbours.

4. The vertical axis wind turbine according to claim 1, wherein each of the plurality of guide vanes extends at a non-zero angle with respect to the radial direction, as seen in a plane normal to the axis of rotation.

5. The vertical axis wind turbine according to claim 1, wherein each of the plurality of guide vanes comprises an inner segment and an outer segment as seen in the radial direction, wherein the inner and outer segments are mutually inclined.

6. The vertical axis wind turbine according to claim 5, wherein the inner and/or outer segment is substantially planar.

7. The vertical axis wind turbine according to claim 5, wherein the inner segment and/or outer segment are substantially triangular or trapezial as seen in plan view, the inner and outer segment meeting along a contact line.

8. The vertical axis wind turbine according to the claim 7, wherein respective contact lines of consecutive vanes extend, as seen in a direction from the top to the bottom, alternatingly radially inwards and radially outwards.

9. The vertical axis wind turbine according to claim 1, wherein the guide vanes extend partially beyond the top and/or bottom in the radial direction.

10. The vertical axis wind turbine according to claim 1, wherein any one or more of the following comprises sheet material, such as sheet metal, in particular steel:
the top;
the bottom;
the guide vanes;
the rotor.

11. The vertical axis wind turbine according to claim 1, wherein the top and/or bottom is annular or disk-shaped.

12. The vertical axis wind turbine according to any of the preceding claims, comprising two, three or more of such stators and rotors stacked coaxially.

13. The vertical axis wind turbine according to claim 12, wherein the guide vanes of adjacent stators are aligned.

14. The vertical axis wind turbine according to claim 12, wherein the rotors of adjacent stators are offset in the circumferential direction.

15. The vertical axis wind turbine according to claim 12, wherein the respective rotors are arranged mutually stationary.

16. The vertical axis wind turbine according to claim 1, further comprising a stand, the stator(s) being fixed to the stand.

17. The vertical axis wind turbine according to claim 16, further comprising a generator fixed on or in the stand and connected to the rotor(s).
